(19) United States
(12) Patent Application Publication
(10) Pub. No.: US 2022/0259829 A1
(43) Pub. Date: Aug. 18, 2022

(54) HYDRAULIC SYSTEM ARCHITECTURES AND BIDIRECTIONAL PROPORTIONAL VALVES USABLE IN THE SYSTEM ARCHITECTURES

(71) Applicant: Danfoss Power Solutions II Technology A/S, Nordborg (DK)

(72) Inventor: Nilesh Anant Sutar, Pune (IN)

(21) Appl. No.: 17/625,197

(22) PCT Filed: Jul. 1, 2020
(86) PCT No.: PCT/EP2020/025310

§ 371 Date: Jan. 6, 2022

Related U.S. Application Data
(60) Provisional application No. 62/871,280, filed on Jul. 8, 2019.

(51) Int. Cl. E02F 9/22

(52) U.S. Cl. CPC E02F 9/2296; F15B 13/0405; E02F 9/2228; E02F 9/2285

(57) ABSTRACT

The present disclosure relates to systems that use a single proportional valve to control raising and lowering of a load. The present disclosure also relates to proportional valves that provide proportional flow control in first and second opposite flow directions through the proportional valve.

### CROSS-REFERENCE TO RELATED APPLICATION

This application is a National Stage application of International Patent Application No. PCT/EP2020/025310, filed on Jul. 1, 2020, which claims priority to U.S. Application No. 62/871,280 filed on Jul. 8, 2019, each of which is hereby incorporated by reference in its entirety.

### TECHNICAL FIELD

The present disclosure relates generally to hydraulic system architectures for use in controlling and powering hydraulic actuators.

### BACKGROUND

Hydraulic system architectures exist for powering and controlling hydraulic actuators such as hydraulic cylinders. Such hydraulic system architectures typically include hydraulic components such as hydraulic pumps, pressure relief valves, and proportional valves for controlling hydraulic fluid flow to and from a given hydraulic actuator. Hydraulic actuators powered and controlled by hydraulic system architectures are commonly used to drive mechanical components integrated as part of off-road equipment such as construction equipment and agricultural equipment.

### SUMMARY

One aspect of the present disclosure relates to a hydraulic system architecture that utilizes a single proportional valve to control hydraulic fluid flow to and from a hydraulic actuator such as a hydraulic cylinder. The hydraulic system architecture can also include other types of valves such as solenoid valves, check valves and pressure relief valves used in combination with the single proportional valve. A proportional valve is a valve controlled by a variable electrical signal.

Variable electrical signals are provided to a solenoid coil that works in combination with an armature to control the stroking of a valve member (e.g., a spool, poppet, or other member) with respect to one or more metering ports.

Typically, the valve member is infinitely positionable and moves in proportion to the magnitude of the electrical signal provided to the solenoid coil. The flow rate through the valve is dependent upon the position of the valve member and thus the magnitude of the electrical signal provided to the solenoid coil. The ability to control the position of the valve member relative to the metering ports allows the rate of hydraulic fluid flow through the valve to be varied and controlled which in turn provides the capability to vary the speed of an actuator being controlled by the proportional valve.

Another aspect of the present disclosure relates to a proportional valve that is configured to provide proportional flow control in first and second opposite flow directions through the valve.

A variety of additional aspects will be set forth in the description that follows. The aspects relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 schematically depicts a hydraulic system architecture in accordance with the principles of the present disclosure;

FIG. 2 is a position control graph for a controller of the hydraulic system architecture of FIG. 1;

FIG. 3 is a cross-sectional view showing an example configuration for a proportional valve usable in the hydraulic system architecture of FIG. 1;

FIG. 4 depicts another hydraulic system architecture in accordance with the principles of the present disclosure, the system architecture is shown in a neutral, load holding state;

FIG. 5 schematically depicts the hydraulic system architecture of FIG. 4 in a raising state;

FIG. 6 illustrates the hydraulic system architecture of FIG. 4 in a lowering state;

FIG. 7 is a cross-sectional view depicting a bi-directional proportional valve in accordance with the principles of the present disclosure in a closed state;

FIG. 8 is another cross-sectional view of the bi-directional proportional valve of FIG. 7 in the closed state;

FIG. 9 the cross-sectional view of FIG. 7 with the bi-directional proportional valve in an open state;

FIG. 10 is the cross-sectional view of the bi-directional proportional valve of FIG. 8 in the open state;

FIG. 11 depicts a lower end of an inner valve body of the bi-directional proportional valve of FIGS. 7-10;

FIG. 12 depicts an upper end of the inner valve body of FIG. 11;

FIG. 13 is a perspective view of the lower end of the inner valve body of FIG. 11;

FIG. 14 is another perspective view of the inner valve body of FIG. 11 showing the side and lower end of the inner valve body;

FIG. 15 is a perspective view showing an upper side of a check seat that mounts within the lower end of the inner valve body;

FIG. 16 is a perspective view showing a lower side of the check seat of FIG. 15;

FIG. 17 depicts an example flow control notch shape that can be used at the lower end of the inner valve body;

FIG. 18 depicts another example flow control notch shape that can be used at the lower end of the inner valve body;

FIG. 19 depicts a further example flow control notch shape that can be used at the lower end of the inner valve body;

FIG. 20 is a graph depicting example plots representative of flow rate vs. valve position for the valve of FIG. 7; the different example plots correspond to different flow control notch shapes provided at the lower end of the inner valve body; and

FIG. 21 is a graph illustrating gap size/valve position vs. solenoid force applied to the inner valve body; the inner valve body stops at a particular gap size when the solenoid force equals a spring force applied to the inner valve body as indicated by the intersection between spring force line 300 and the solenoid force corresponding to a given control command.

### DETAILED DESCRIPTION

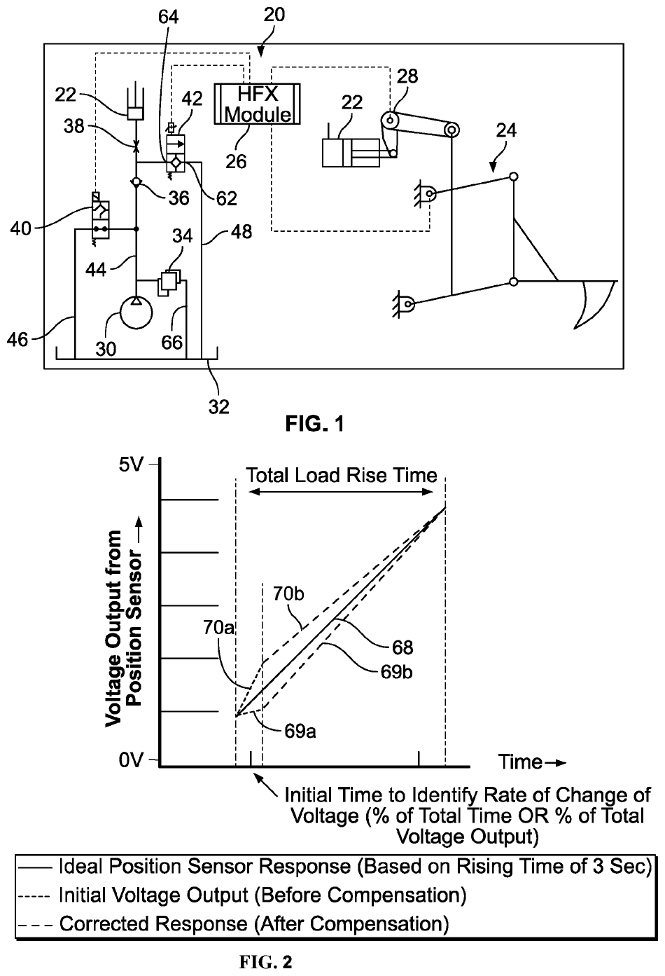

FIG. 1 depicts a hydraulic system architecture 20 in accordance with the principles of the present disclosure. The hydraulic system architecture 20 powers and controls an actuator 22 (e.g., a hydraulic cylinder) coupled to a mechanical device 24. In certain examples, the mechanical device 24 can be integrated as part of an off-road vehicle such as a tractor or a piece of construction equipment. In certain examples, the mechanical device 24 can include one or more pivot linkages that are moved by the actuator 22. In certain examples, the mechanical device 24 can include a pivotal arm or boom that in certain examples may be coupled to a bucket, a blade, a shovel, a piece of agricultural equipment, or the like.

Referring again to FIG. 1, the hydraulic system architecture 20 includes an electronic controller 26 that can have one or more processors and can interface with software, firmware and/or hardware. The processors can include digital analog processing capabilities and can interface with memory (e.g., random access memory, read only memory, or other data storage). In certain examples, the processors can include a programmable logic controller, one or more microprocessors, or like structures.

Referring still to FIG. 1, the electronic controller 26 interfaces with position sensors 28 that provide feedback information relating to the position of the mechanical device 24. In one example, position sensors 28 can include rotary sensors that sense a rotary position of a component of a mechanical device 24 or linear sensors that can sense linear motion of a mechanical device.

The hydraulic system architecture 20 also includes a hydraulic pump 30, a hydraulic tank 32 (e.g., a reservoir), a pressure relief valve 34, a one-way check valve 36, an orifice 38, a solenoid valve 40, and a single proportional valve 42. The pump 30 has an input side connected to tank 32 and an output side coupled to a hydraulic flow line 44 for hydraulically connecting the pump 30 to the actuator 22. The orifice 38 and the one-way check valve 36 are positioned along the hydraulic flow line 44. The one-way check valve 36 allows hydraulic fluid to flow through the hydraulic flow line 44 in a direction toward the actuator 22, and prevents hydraulic fluid from flowing through the flow line 44 in a direction away from the actuator 22 and toward the pump 30. The hydraulic system architecture 20 further includes a recirculation flow line 46 that branches from the hydraulic flow line 44 at a location between the pump 30 and the one-way check valve 36. The solenoid valve 40 is located along the recirculation flow line 46 and is movable between an open position (see FIG. 1) and a closed position.

The hydraulic system architecture 20 also includes a branch flow line 48 that branches from the hydraulic flow line 44 at a location between the one-way check valve 36 and the orifice 38, and that extends to tank 32. The proportional valve 42 is positioned along the branch flow line 48. The proportional valve 42 can be in a closed position (see FIG. 1) or can be moved from the closed position to one of a plurality of proportional flow positions for varying the flow rate of hydraulic fluid through the proportional valve 42.

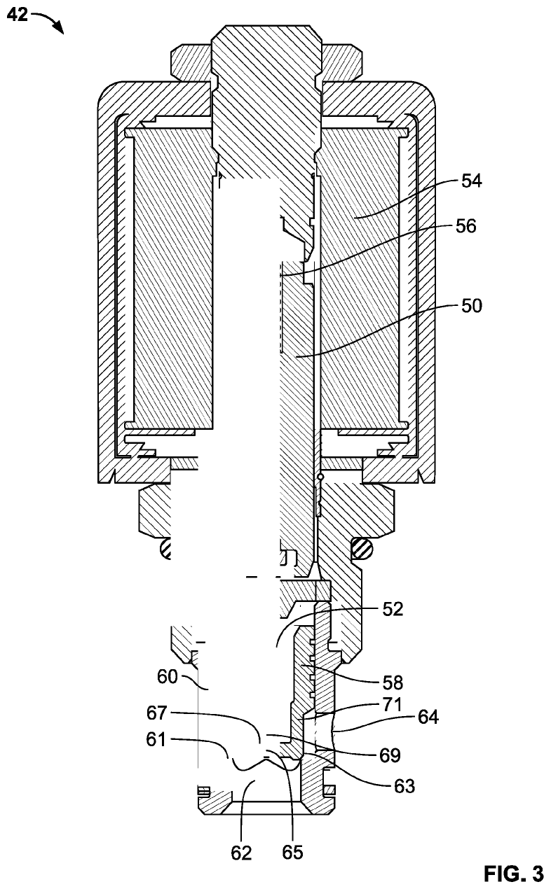

FIG. 3 is a cross-sectional view of an example configuration of the proportional valve 42. In one example, the proportional valve 42 is a proportional valve sold by Eaton Corporation having Model No. ESVI-10-C which provides proportional flow control when energized, is normally closed when de-energized, and includes a poppet-style configuration. As shown at FIG. 3, the proportional valve 42 includes an armature 50 coupled to a pilot poppet 52. A coil 54 surrounds the armature 50. The armature 50 and the pilot poppet 52 are biased in a downward direction by a spring 56.

The pilot poppet 52 is positioned within a main poppet 58 located within a valve body 60. The valve body 60 defines a first port 62 and a second port 64. When the proportional valve 42 is in the de-energized position, flow is blocked from the second port 64 to the first port 62, and is allowed from the first port 62 to the second port 64. When the proportional valve 42 is energized, flow is allowed from the second port 64 to the first port 62 with the valve flow being proportional to the magnitude of an electrical control signal (e.g., an electrical current magnitude) applied to the coil 54.

The first and second ports 62, 64 are also labeled at FIG. 1.

The valve body 60 defines a valve seat 61 that interfaces with an end 63 of the main poppet 58. The end 63 of the main poppet 58 defines an opening 65 for providing fluid communication between the first port 62 and an interior volume of the main poppet 58. The main poppet 58 defines an interior valve seat 67 that interfaces with an end 69 of the pilot poppet 52 such that the pilot poppet 52 functions to open and close the opening 65. The main poppet 58 also defines a side orifice 71 that provides fluid communication between the second port 64 and the interior of the main poppet 58.

When the proportional valve 42 is de-energized, the proportional valve 42 operates as a one-way check valve that allows flow through the valve 42 in a direction from the first port 62 to the second port, but prevents flow through the valve 42 in a direction from the second port 64 to the first port 62. Specifically, higher pressure at the first port 62 than the second port 64 causes the main poppet 58 to lift off the valve seat 61 against the bias of the spring 56. This allows hydraulic fluid to flow between the valve seat 61 and the end 63 of the main poppet 58 from the first port 62 to the second port. Higher pressure at the second port 64 pressurizes the interior of the main poppet 58 via the side orifice 71 thereby forcing the main poppet 58 to the closed position with the lower end 63 against the valve seat 61. Since the valve 42 is de-energized, the spring 56 biases the end 69 of the pilot poppet 52 against the interior valve seat 67 such that the opening 65 is blocked thereby allowing the hydraulic pressure to be maintained in the interior of the main poppet 58

When the valve 42 is energized, the armature 50 moves in proportion to the magnitude of the electrical control signal to lift the pilot poppet 52 a pre-determined distance off the interior valve seat 67. The pre-determined distance is determined by the magnitude of the control signal. In the case where the pressure at the second port 64 is greater than at the first port 62, lifting of the pilot poppet 52 causes the pressure in the interior of the main poppet 58 to be relieved through the opening 65 faster than the pressure can be replenished through the orifice 71. When this occurs, hydraulic pressure at the second port 64 acting on the exterior of the main poppet 58 provides sufficient force to lift the main poppet 58 off the valve seat 61 and open fluid communication between the first and second ports 62, 64. Flow then occurs from the second port 64 to the first port 62 through the region defined between the lower end of the main poppet 58 and the valve seat 61. The main poppet 58 lifts until the main poppet 58 re-engages the end 69 of the pilot poppet 52. Thus, the amount the main poppet 58 moves is dependent upon the amount of movement of the pilot poppet 52 which is dependent upon the magnitude of the control signal provided to the coil 54. The valve seat 61 and/or the main poppet 58 have opposing shapes (e.g., notched shapes) that vary the size of the flow passage between the lower end of the main poppet 58 and the valve seat 61 based on the amount the main poppet 58 is lifted relative to the valve seat 61.

Thus, the interfacing shapes allow the flow rate from the second port 64 to the first port 61 to be controlled in proportion to the position of the main poppet 58 relative to the valve seat 61. Different opposing shapes (e.g., square notches, rounded notches, triangular notches, rectangular notches and combinations thereof) and shape sizes can be used to provide different proportional flow characteristics. As indicated above, the position of the main poppet 58 is controlled by the position of the pilot poppet 52 which is determined by the magnitude of the electrical control signal provided to the coil 54. Thus, the flow rate from the second port 64 to the first port 62 can be controlled based on the magnitude of the control signal provided to the coil 54.

Referring back to FIG. 1, a pressure relief line 66 branches from the hydraulic flow line 44 at a location between the recirculation flow line 46 and the pump 30. The pressure relief line 66 extends from the hydraulic flow line 44 to tank 32. The pressure relief valve 34 is positioned along the pressure relief line 66. When the pressure within the hydraulic flow line 44 exceeds a pressure setting of the pressure relief valve 34, the pressure relief valve 34 opens to allow hydraulic fluid to be dumped to tank 32 through the pressure relief line 66. Otherwise, the pressure relief valve 34 is closed to block fluid communication between the hydraulic flow line 44 and tank 32.

The electronic controller 26 interfaces with the position sensors 28 to receive feedback regarding the position of the mechanical device 24. The electronic controller 26 also interfaces with the solenoid valve 40 and the proportional valve 42 to control operation of these valves. It will be appreciated that the electronic controller 26 can control the magnitude of current provided to the proportional valve 42 to control the flow rate through the valve 42. The electronic controller 26 can also control whether the solenoid valve 40 is open or closed. The solenoid valve 40 can normally be open, but can close when energized.

FIG. 2 shows an example motion control graph used by the electronic controller 26 to control positioning of the mechanical device 24. The solid line 68 represents an expected position of the mechanical device 24 over time dependent upon an electrical current level provided to the proportional valve 42. If the speed of the mechanical device 24 is slower than the expected speed as indicated by line 69a, an increased current can be provided to the proportional valve 42 to provide speed compensation as shown by line 69b. In contrast, if the sensed speed of the mechanical device 24 is greater than the expected speed, the electrical current provided to the proportional valve 42 can be reduced. Line 70a is representative of a sensed speed greater than the expected speed, and line 70b shows speed compensation caused by reducing the current to the proportional valve 42.

When the hydraulic system architecture 20 is in a load holding state, the proportional valve 42 is closed and the solenoid valve 40 is open such that flow from the pump 30 is directed to tank 32 through the recirculation flow line 46. The one-way check valve 36 and the closed proportional valve 42 cooperate to hydraulically lock the actuator 22.

When the hydraulic system architecture 20 is in a raising state in which flow is directed to the actuator 22, the solenoid valve 40 is energized to close flow from the pump 30 to the tank 32 via line 46. Concurrently, the proportional valve 42 is energized with a control signal the magnitude of which determines the rate of flow permitted through the valve 42. The control signal provided to the proportional valve 42 is preferably varied in magnitude to control the ratio of flow from the pump that is directed to the actuator 22 and to tank 32. To reduce the flow rate to the actuator 22, the proportional flow through the proportional valve 42 is increased so that more flow is directed to tank 32 and less flow is directed to the actuator. In contrast, to increase the flow rate to the actuator 22, the proportional flow through the proportional valve 42 is decreased so that less flow is directed to tank and more flow is directed to the actuator.

In this way, the rate of movement of the actuator 22 during raising can be controlled based on the position of the proportional valve 42.

The hydraulic system architecture 20 can also be operated in a lowering state in which hydraulic fluid is expelled from the actuator 22. In the lowering state, the solenoid valve 40 is open such that flow from the pump 30 is recirculated to tank. Also, the proportional valve 42 is proportionally controlled to control the rate of flow through the valve 42 to tank 32. In this way, the rate of movement of the actuator 22 during lowering can be controlled based on the position of the proportional valve 42.

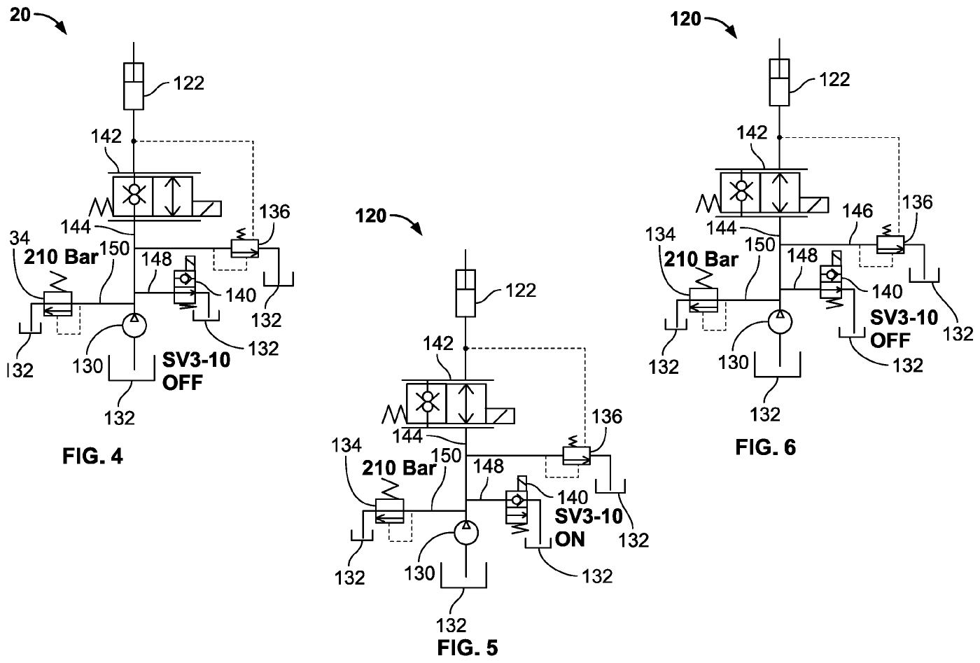

FIGS. 4-6 depict another hydraulic system architecture 120 in accordance with the principles of the present disclosure. The hydraulic system architecture 120 is adapted for powering and controlling the speed and direction of an actuator 122. The hydraulic system architecture 20 includes a pump 130, a tank 132, a high pressure relief valve 134, a pilot operated pressure relief valve 136, a solenoid valve 140, and a single bi-directional proportional valve 142. A main hydraulic flow line 144 extends from an output side of the pump 130 to the actuator 122. An input side of the pump 130 is coupled to tank. The bi-directional proportional valve 142 controls flow through the main hydraulic flow line 144. The pilot operated pressure relief valve 136 is positioned along a pressure relief line 146 that extends from the main hydraulic flow line 144 to tank 132. The pressure relief line 146 connects to the main hydraulic flow line 144 at a location between the bi-directional proportional valve 142 and the pump 130.

The hydraulic system architecture 120 also includes a recirculation line 148 and a second pressure relief line 150. The solenoid valve 140 is positioned along the recirculation line 148 and is adapted to open and close the recirculation line 148. The line 148 is open when the solenoid valve 140 is de-energized and is closed when the solenoid valve 140 is energized. The recirculation line 148 extends from the main hydraulic flow line 144 to tank 132 and connects to the hydraulic flow line 144 at a location between the first pressure relief line 146 and the pump 130. The second pressure relief line 150 extends from the main hydraulic flow line 144 to tank and connects to the main hydraulic flow line 144 the location between the recirculation line 148 and the pump 130. The high pressure relief valve 134 is positioned along the second pressure relief line 150. The high pressure relief valve 134 is configured to open fluid communication between tank and the main hydraulic flow line 144 when the pressure in the main hydraulic flow line 144 exceeds the pressure setting of the high pressure relief valve 134.

Otherwise, the high pressure relief valve 134 is closed so that the second pressure relief line 150 is closed.

FIG. 4 shows the hydraulic system architecture 120 in a load holding state in which the bi-directional valve 142 is closed such that fluid communication is blocked between the actuator 122 and the pump 130. In this configuration, the actuator 122 is hydraulically locked in place. In this configuration, the solenoid valve 140 can be de-energized so as to be in an open position that allows fluid output from the pump 130 to be directed to tank through the recirculation line 148.

FIG. 5 shows the hydraulic system architecture 120 in a raising mode in which the bi-directional valve 142 is energized to control the rate of hydraulic fluid flow that is provided from the pump 130 to the actuator 122. Thus, the rate of flow provided to the actuator 122 and thus the speed of the actuator 122 can be varied by varying the electrical current provided to the bi-directional proportional valve 142. The amount of electrical current controls a flow passage size through the valve 142 and controls a flow rate through the valve in a first state direction through the valve. In the raising mode, the solenoid valve 140 is closed and excess flow from the pump 130 is directed to tank 132 through the pilot operated pressure relief valve 136. For efficiency purposes, the pilot operated pressure relief valve 136 has a pilot varied relief pressure value that is maintained just above the working pressure (e.g., head pressure) of the actuator 122 depending on the spring margin pressure of the valve 136. During raising, a position sensor can communicate the rate of raising to a system controller, and the controller can adjust the control command to the valve 142 to adjust the flow rate though the valve to achieve the desired raising speed.

FIG. 6 shows the hydraulic system architecture 120 in a lowering state in which the bi-directional proportional valve 142 is again energized to open the hydraulic flow line 144. Hydraulic fluid from the actuator 122 is directed through the bi-directional proportional valve 142 and through the solenoid valve 140 to tank 132. The solenoid valve 140 is de-energized to the open state. The proportional valve 142 can control the rate of flow exiting the actuator 122 and thus the speed of lowering of the actuator 122 by varying the electrical current provided to the bi-directional valve 142. It will be appreciated that by varying the electrical current to the bi-directional proportional valve 142, the flow path through the valve 142 size and thus the flow rate through the bi-directional valve 142, as the actuator 122 is lowered can be controlled.

The flow rate through the valve 142 during lowering is controlled by the valve 142 and is in a second direction opposite from the first direction. During lowering, the position sensor can communicate the rate of lowering to the system controller, and the controller can adjust the control command to the valve 142 to adjust the flow rate though the valve to achieve the desired lowering speed.

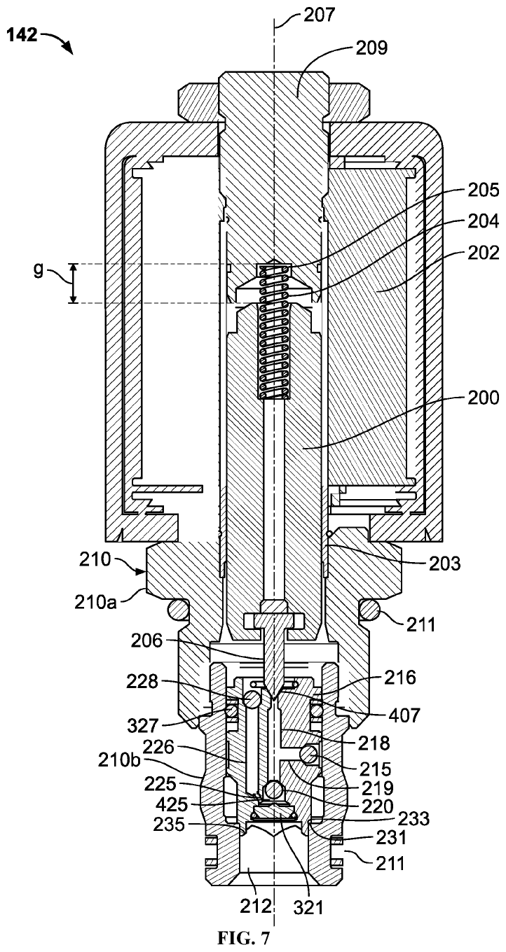

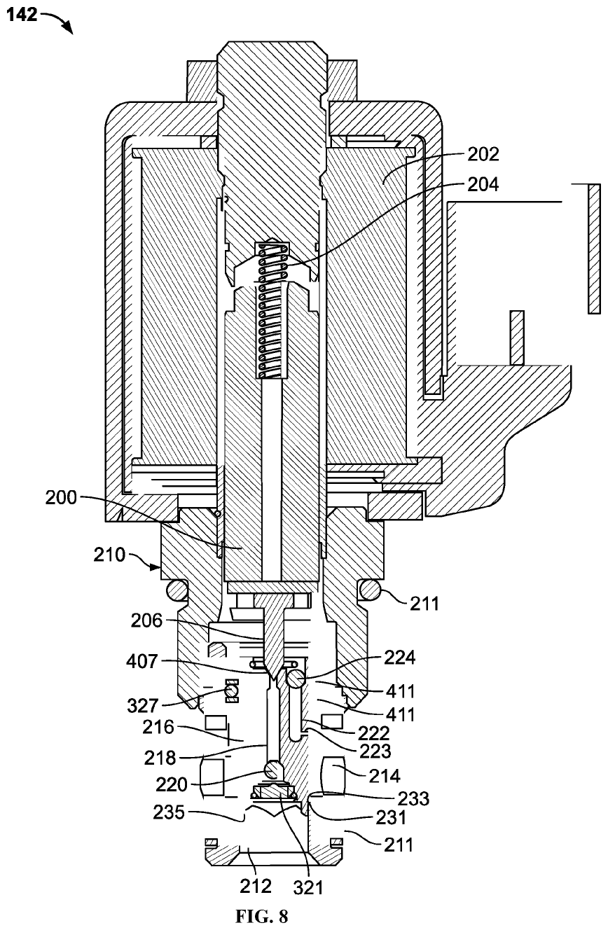

FIGS. 7 and 8 show an example configuration for the bi-directional proportional valve 142. The bi-directional valve 142 includes a solenoid arrangement including a moveable armature 200 surrounded by a coil 202. The moveable armature 200 is positioned within a non-magnetic core tube 203 located between the moveable armature 200 and the coil 202. The moveable armature 200 is biased in a downward direction by a spring 204 and is axially moveable relative to the coil 202 within the core tube 203 along an axis 207. An upper end of the moveable armature 200 is axially separated from a fixed armature 205 by a gap g. The size of the gap g varies as the moveable armature 200 moves relative to the coil 202 along the axis 207. The fixed armature 205 fits in an upper end of the core tube 203. A valve member 206 (e.g., a valve pin) is secured to a lower end of the moveable armature 200 such that the valve member 206 moves axially with the moveable armature 200 along the axis 207.

The solenoid arrangement mounts on an outer valve body 210 which defines a first port 212 and a second port 214. The outer valve body 210 includes first and second valve body parts 210a, 210b. Exterior seals 211 mount on the outer valve body 210 for sealing above and below the second port 214 when the outer valve body 210 is inserted (e.g., threaded) into an opening of a valve manifold. An inner valve body 216 is positioned within the outer valve body 210.

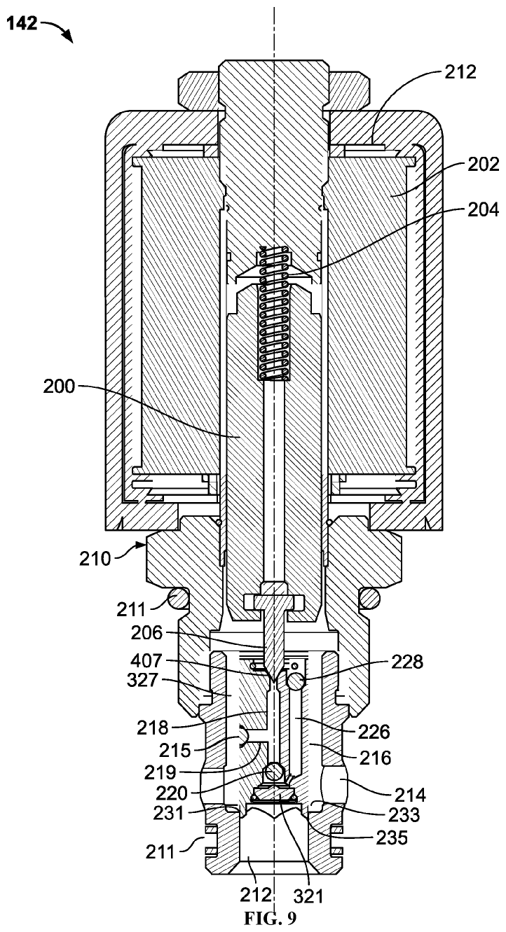

The inner valve body 216 (e.g., a main poppet) defines a central passage 218 (see FIGS. 7-10) that can be opened and closed at its lower end by a check ball 220. The check ball 220 allows hydraulic fluid to exit the lower end of the passage 210, but prevents hydraulic fluid from entering the lower end of the passage. Thus, the check ball 220 allows flow through the central passage 218 from the top of the inner valve body 216 to the first port 212 and prevents flow in the opposite direction. A side passage 219 (see FIGS. 7 and 9) provides fluid communication between the second port 214 and the central passage 218. A check ball 215 allows flow through the side passage 219 from the second port 214 to the central passage 218 and prevents flow through the side passage 219 in the opposite direction.

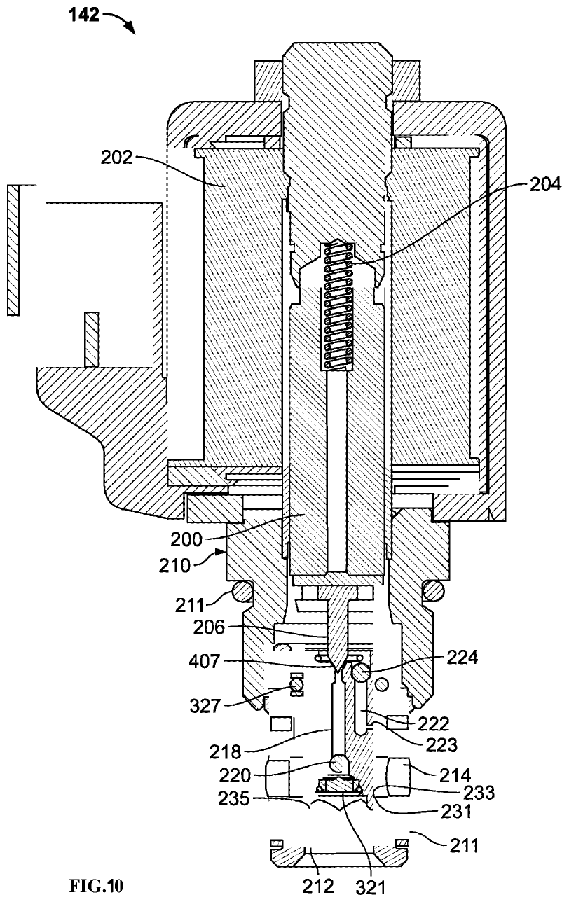

The inner valve body 216 also defines a passage 222 (see FIGS. 8 and 10) that provides fluid communication between the second port 214 and a top side of the inner valve body 216. An upper end of the passage 222 is opened and closed by a check-valve 224 that allows flow through the passage 222 from the second port 214 to the top side of the inner valve body 216 and prevents flow through the passage 222 in the opposite direction. The passage 222 includes an orifice 223.

The inner valve body 216 also defines passage 226 (see FIGS. 7 and 9) which extends from a bottom of the inner valve body 216 to a top of the inner valve body 216. A lower end of the passage 226 is in fluid communication with the first port 212. A check ball 228 at top end of the passage 226 allows flow through the passage 226 from the first port 212 to the top side of the inner valve body 216 and prevents flow through the passage 226 in the opposite direction. The passage 226 includes an orifice 225. A retaining ring 409 retains the check balls 224, 228 at the top of the inner valve body 216 (see FIG. 12).

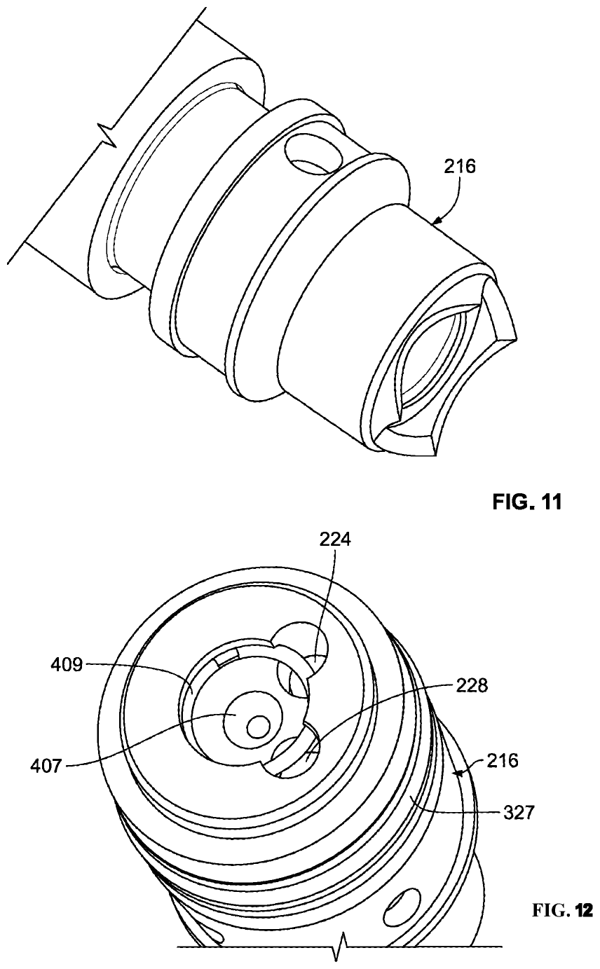

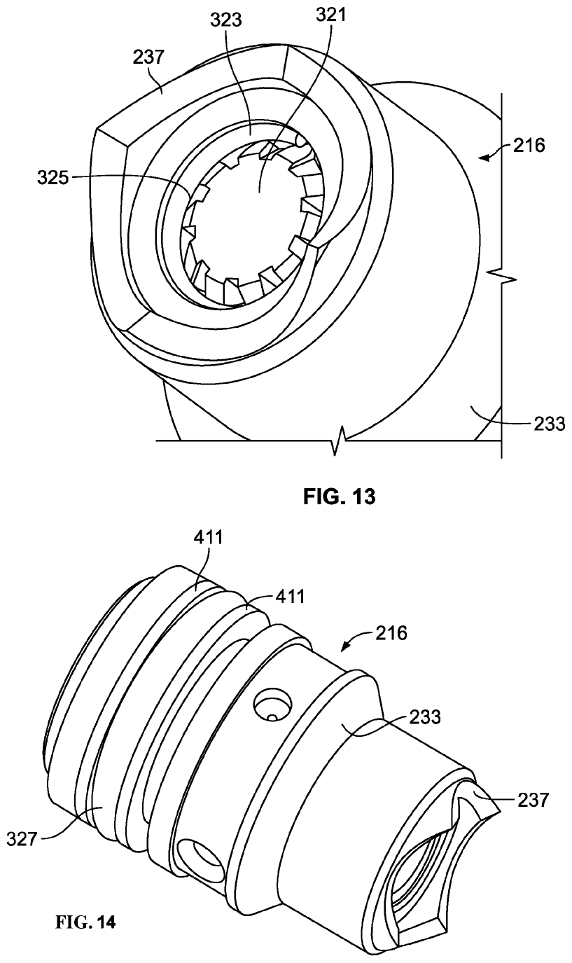

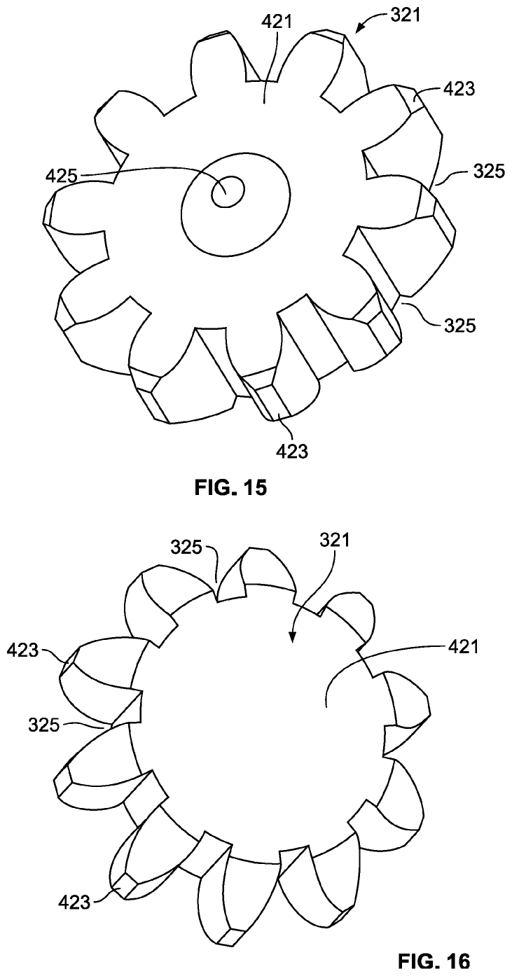

The check ball 220 is retained in the inner valve body 216 by a check seat 321 held within the lower end of the inner valve body 216 by a retaining ring 323 such as a snap-ring (see FIG. 13). The check seat 321 includes peripheral notches 325 (see FIGS. 13, 15 and 16) for allowing hydraulic fluid from the central passage to flow axially past the check seat 323 to first port 212 and for allowing fluid from the first port 212 to flow past the axial check seat 223 to the passage 226. A seal 327 such as an o-ring mounts on the exterior of the inner valve body 216 and is adapted for sealing against an interior of the outer valve body 210.

The seal 327 is mounted axially between back-up washers 411 and functions to prevent leakage of hydraulic fluid axially along the exterior of the inner valve body 216 between the second port 214 and the upper chamber located above upper side of the inner valve body 216. The outer valve body 210 defines an inner valve seat 231.

The check seat 321 has a generally gear shaped configuration with a central portion 421 and a plurality of teeth 423 that project radially outwardly from the central portion. The notches 325 are defined circumferentially between the teeth 423 and function to define flow passages for allowing hydraulic fluid to flow from the first port 212 to the passage 226 when the hydraulic pressure at the first port 212 is higher than the hydraulic pressure at the chamber above the inner valve body 216.

The notches 325 also allowing hydraulic fluid to flow from the passage 218 to the first port 212 when the valve 206 opens the passage 218 and the hydraulic pressure at the chamber above the inner valve body 216 is higher than the pressure at the first port 212. The check ball 220 prevents fluid from the first port 212 from flowing into the passage 218. The check seat 321 and the ring 323 cooperate to retain the check ball 220 within the lower end of the inner valve body 216. The top side of the check seat 321 includes a central axial projection 425 that is adapted to engage the check ball 220 when the check ball 220 moves to an open position to allow flow from the passage 218 through the notches 325 to the first port 212.

An upper end of the center passage 218 defined at an upper side of the inner valve body 216 can be opened and closed by the lower end of the valve member 206. When the solenoid arrangement is de-energized, the spring 204 biases the valve member 206 downwardly against a valve seat 407 at the upper end of the center passage 218 such that the upper end of the center passage 218 is blocked/closed. Thus, the passage 218 is normally closed. When the solenoid arrangement is de-energized, the center passage 218 is blocked and the valve 142 is closed (see FIGS. 7 and 8). When the valve 142 is closed, a ring portion 233 seats against the inner valve seat 231 such that the inner valve body 216 blocks fluid communication between the first and second ports 212, 214 and flow is prevented from moving through the valve 142 from the first port 212 to the second port 214 and vice-versa. With the solenoid de-energized, the spring 204 biases the valve member 206 against the top side of the inner valve body 216 such that the inner valve body 216 is biased toward the closed position by the spring 204.

Additionally, with the valve de-energized and the center passage 218 blocked, the high pressure side of the valve 142, whether it is at the first port 212 or the second port 214, will generate pilot pressure above the inner valve body 216 that holds the inner valve body 216 in the closed position.

When the solenoid arrangement is energized, the valve 142 operates in a proportional flow mode in which flow through the valve 142 between the first and second ports 212, 214 is capable of being controlled proportionally in a first direction from the first port 212 to the second port 214 and is capable of being controlled proportionally in a second direction from the second port 214 to the first port 212. When the solenoid arrangement is energized, the valve member 206 lifts off the inner valve body 216 a distance proportional to a magnitude of the control signal used to energize the solenoid arrangement and the gap g shortens a distance equal to the distance of movement of the valve member 206. When the valve member 206 lifts off the inner valve body 216, the central passage 218 is opened and pilot pressure causes the inner valve body 216 to follow the valve member 206 thereby causing the ring portion 233 to lift from the inner valve seat 231 thereby opening fluid communication between the first and second ports 212,214 via a flow passage defined between an interior of the outer valve body 210 and an exterior region 235 of the inner valve body 216 (see FIGS. 9 and 10). The cross-sectional area of the flow passage varies with the position of the inner valve body 216, which is determined by the position of the valve member 206 which functions as a stop when the inner valve body 216 lifts from the valve seat 231. The position of the valve member 206 is dependent upon the magnitude of the control signal (e.g., electrical current) used to energize the solenoid arrangement.

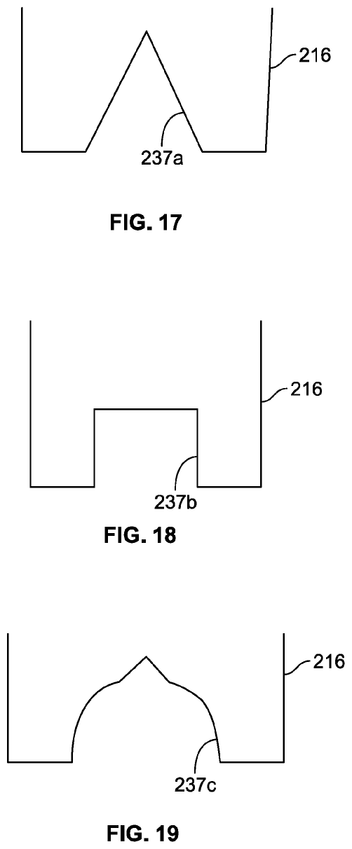

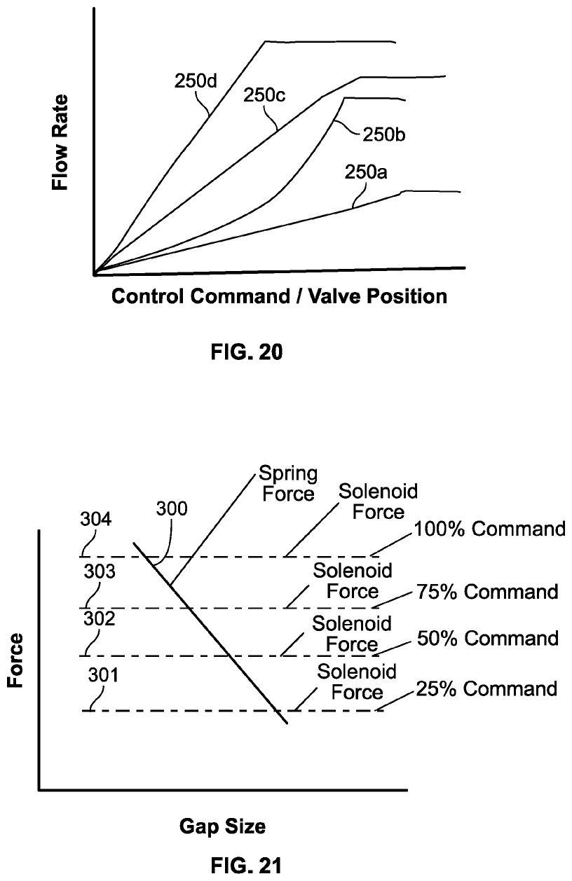

The exterior region 235 of the inner valve body 216 has a shape that causes the cross-sectional area of the flow passage defined between the outer valve body 210 and the inner valve body 216 to vary with the axial position of the inner valve body 216 relative to the outer valve body 210. As depicted at FIG. 14, the shape interface curved notches 237. It will be appreciated that the flow control characteristics of the valve 142 can be varied by using flow control shapes having different shapes and sizes at the exterior region 235. For example, the shapes can include different shaped notches such as triangular notches 237a (see FIG. 17), square or rectangular notches (see FIG. 18), notches 237c having combinations of shapes (see FIG. 19) or other shapes to provide different dependent relationships between the control command/valve position and flow rate. FIG. 20 show different example dependent relationships 250a, 250b, 250c, 250d between flow rate and valve position. The example dependent relationships can be linear relationships, curved relationships, linear relationships having different slopes and combinations thereof. The different relationships result in valves having different rates of change of the valve passage cross-sectional areas and thus different rates of change of flow rates for given distances of linear movement of the inner valve bodies.

FIG. 21 shows an example proportional relationship between the magnitude of the control signal (e.g., the magnitude of the electrical current provided to the coil of the solenoid) and the position of the inner valve body when the valve is operating in the energized/proportional flow control mode. Specifically, FIG. 21 shows a relationship between the size of the gap g in relation to the axial force applied to the armature 200 by the spring 204 and the coil 202. The size of the gap g corresponds the position of the armature 200, the valve member 206 and the inner valve body 216. The armature 200 stops movement when the spring force applied to the armature is equal and opposite the electromagnetic force generated when electrical current is applied though the coil 202. At FIG. 21, line 300 depicts the force of the spring 204. Further, line 301 depicts the electromagnetic force applied to the armature 200 by the coil 202 when a control signal having a value of 25 percent of the maximum control command is applied. Line 302 depicts the electromagnetic force applied to the armature 200 by the coil 202 when a control signal having a value of 50 percent of the maximum control command is applied. Line 303 depicts the electromagnetic force applied to the armature 200 by the coil 202 when a control signal having a value of 75 percent of the maximum control command is applied. Line 304 depicts the electromagnetic force applied to the armature 200 by the coil 202 when a control signal having a value of 100 percent of the maximum control command is applied. The armature position is defined where the force line corresponding to a given control command magnitude intersects the spring force line 300. A large plurality (e.g., infinite) of positions of the inner valve body 216 and corresponding a plurality of different flow rates can be established by varying the magnitude of the control command and thus the magnitude of the electromagnetic force applied to the armature.

As indicated above, flow rate through the valve 142 is controllable in a first direction extending from the first port 212 to the second port 214, and in a second opposite direction from the second port 214 to the first port 212.

Proportional flow control is provided by energizing the solenoid of the valve 142 with a control signal having a magnitude that corresponds to the desired flow rate. By adjusting the magnitude of the control signal, the size of the cross-sectional area of the valve passage between the ports 212, 214 can be adjusted thereby adjusting the flow rate between the ports 212, 214. Motion of the hydraulic actuator being controlled by the valve 142 can be monitored and used to provide a feedback loop for modifying the control signal to ensure the hydraulic actuator moves at the desired speed. The passages 218,219,222, and 226 define valve pilot flow paths configured such that when the solenoid is energized and the valve member 206 lifts from the center passage 218, the inner valve body 216 moves by pilot pressure from the closed position to a proportional flow position in which the inner valve body 216 contacts the valve member 206 and a controlled rate of flow is permitted through the valve 142 between the first and second ports 212, 214.

When the valve 142 is de-energized, the valve member 206 closes the top end of the center passage 218 to block fluid communication between the top of the inner valve body 216 and the passage 218. Also, with the valve 142 de-energized, the inner valve body 216 is the closed position in which fluid flow is prevented by the inner valve body 216 from flowing in both directions between the first and second ports 212, 214. In a first condition in which the first port 212 has a higher pressure than the second port 214, the region above the inner valve body 216 is pressurized by pilot pressure from the first port 212 through the passage 226. The pressure above the inner valve body 216 acts on the top of the inner valve body 216 to hold the inner valve member 216 in the closed position. In this first condition, to provide proportionally controlled flow from the first port 212 to the second port 214, the valve is energized causing the valve member 206 to lift from the top of the center passage 218. When this occurs, the region above the inner valve body 216 de-pressurizes via fluid communication with the second port 214 through the central passage 218 and the side passage 219.

The orifice 225 assists in this de-pressurization by restricting flow from the first port 212 to the region above the inner valve body 216.

With the region above the inner valve body 216 de-pressurized, the higher pressure at the first port 212 causes the inner valve body to lift off the valve seat 231 and move into contact with the valve member 206 at a valve position corresponding to a desired flow rate from the first port 212 to the second port 214. When the valve is de-energized, the spring 204 maintains the valve member 206 in contact with the top of the inner valve body 216 thereby maintaining blockage of the central passage 218.

This allows the region above the inner valve body 216 to re-pressurize causing the inner valve body 216 to return and remain in the closed position via pilot pressure acting on the top of the inner valve body 216.

In a second condition in which the second port 214 has a higher pressure than the first port 212, the region above the inner valve body 216 is pressurized by pilot pressure from the second port 214 through the passage 222. The pressure above the inner valve body 216 acts on the top of the inner valve body 216 to hold the inner valve member 216 in the closed position. In this second condition, to provide proportionally controlled flow from the second port 214 to the first port 212, the valve is energized causing the valve member 206 to lift from the top of the center passage 218. When this occurs, the region above the inner valve body 216 de-pressurizes via fluid communication with the first port 212 through the central passage 218. The orifice 223 assists in this de-pressurization by restricting flow from the second port 214 to the region above the inner valve body 216. With the region above the inner valve body 216 de-pressurized, the higher pressure at the second port 214 acts on the exterior of the inner valve body 216 causing the inner valve body 216 to lift off the valve seat 23 land move into contact with the valve member 206 at a valve position corresponding to a desired flow rate from the second port 214 to the first port 212. When the valve is de-energized, the spring 204 maintains the valve member 206 in contact with the top of the inner valve body 216 thereby maintaining blockage of the central passage 218. This allows the region above the inner valve body 216 to re-pressurize causing the inner valve body 216 to return and remain in the closed position via pilot pressure acting on the top of the inner valve body 216.

From the forgoing detailed description, it will be evident that modifications and variations can be made without departing from the spirit and scope of the disclosure.

What is claimed is:

1. A hydraulic system for raising and lowering a component via a hydraulic actuator, the hydraulic system comprising:
a hydraulic pump; and
a single proportional flow control valve for proportionally controlling flow to the actuator during raising of the component and for proportionally controlling flow from the actuator during lowering of the component.

2. The hydraulic system of claim 1, wherein the single proportional control valve is configured to provide bi-directional proportional flow control through the proportional control valve.

3. The hydraulic system of claim 1, wherein during lowering of the component, flow from the actuator is directed through the single proportional control valve to tank, and wherein during raising of the component, the single proportional control valve proportions flow from the hydraulic pump between the actuator and tank.

4. A hydraulic device comprising:
a proportional valve that is configured to provide proportional flow control in first and second opposite flow directions through the proportional valve.

5. The hydraulic device of claim 4, wherein the proportional valve includes an outer valve body and an inner valve body within the outer valve body, the inner valve body being movable relative to the outer valve body along an axis.

6. The hydraulic device of claim 5, wherein the outer valve body defines first and second ports, wherein the outer valve body defines an inner valve seat, wherein a proportional flow interface is defined between the outer valve body and the inner valve body, wherein the proportional flow interface defines a main flow passage between the first and second ports, wherein the inner valve body is movable along the axis relative to the outer valve body between a closed valve position and a plurality of proportional flow positions, wherein the inner valve body engages the inner valve seat to block fluid communication between the first and second ports via the main flow passage when the inner valve body is in the closed position, wherein the proportional flow interface provides the main flow passage with different cross-sectional areas corresponding to each of the proportional flow positions, and wherein the proportional valve includes a solenoid arrangement for moving the inner valve body to the closed position and the plurality of different proportional flow positions, the solenoid arrangement having a spring-biased armature that is moved to a plurality of different armature positions along the axis dependent upon a magnitude of an electrical current provided to a coil of the solenoid arrangement, and wherein the different armature positions correspond to the closed position and the different proportional flow positions.

7. The hydraulic device of claim 5, wherein the inner valve body defines a first pressurizing path for pressurizing a region above the inner valve body via pressure from the first port, wherein the inner valve body defines a second pressurizing path for pressurizing the region above the inner valve body from the second port, wherein the inner valve body defines a first de-pressurization path for de-pressurizing the region above the inner valve body via fluid communication with the second port, wherein the inner valve body defines a second de-pressurization path for de-pressurizing the region above the inner valve body via fluid communication with the first port, and wherein the hydraulic device includes a valve member coupled to the armature for opening and closing the first and second de-pressurization paths.

8. The hydraulic device of claim 7, wherein the first pressurizing path, the second pressurizing path, the first de-pressurizing path, and the second de-pressurizing path each include a one-way check valve.

9. The hydraulic device of claim 7, wherein the first pressurizing path and the second pressurizing path each include an orifice.

10. The hydraulic device of claim 9, wherein the valve member is coaxial with the axis.

11. The hydraulic device of claim 7, wherein the first and second de-pressurizing paths share a passage that is open and closed by the valve member.

12. The hydraulic device of claim 11, wherein the passage shared by the first and second de-pressurizing paths has an upper end at a top end of the inner valve body, and wherein the valve member is adapted to open and close the upper end of the passage, and wherein contact between the valve member and the top end of the inner valve body controls an axial position of the inner valve body.

13. The hydraulic system of claim 1, further comprising a control system including a sensor for monitoring a position of the component and for providing position feedback used to electronically adjust the single proportional control valve to provide for motion correction.

14. The hydraulic system of claim 1, wherein during lowering of the component, flow from the actuator is directed through the single proportional control valve to tank, and wherein during raising of the component, flow from the hydraulic pump is directed through the single proportional control valve to the actuator.
